(19) United States
(12) Patent Application Publication
(10) Pub. No.: US 2014/0293417 A1
(43) Pub. Date: Oct. 2, 2014

(54) EYEGLASS COMPONENT, EYEGLASSES, AND EYEGLASS COMPONENT MANUFACTURING METHOD

(71) Applicant: ARISAWA MFG. CO., LTD., Niigata (JP)

(72) Inventors: Tatsuya SATO, Niigata (JP); Kazuhiro URA, Niigata (JP); Yasuaki UMEZAWA, Niigata (JP)

(73) Assignee: ARISAWA MFG. CO., LTD., Niigata (JP)

(21) Appl. No.: 14/226,783

(22) Filed: Mar. 26, 2014

(30) Foreign Application Priority Data
Mar. 29, 2013 (JP) 2013-074310

(51) Int. Cl. G02B 27/26

(52) U.S. Cl. CPC G02B 27/26
USPC 359/465; 264/1.31

(57) ABSTRACT

It is difficult to handle a right eye region and a left eye region that are formed separately. Therefore, provided is an eyeglass component comprising a polarization plate that has one absorption axis and a right eye region and left eye region arranged such that, when the eyeglass component is worn by a user, the right eye region is positioned in front of a right eye of the user and the left eye region is positioned in front of a left eye of the user; and a polarized light modulating layer that is layered on the polarization plate, has a first optical axis that modulates polarized light in the right eye region, includes a second optical axis that is in a different direction than the first optical axis and modulates polarized light in the left eye region, and has the right eye region and the left eye region formed integrally.

The contents of the following Japanese patent application are incorporated herein by reference:

No. 2013-074310 filed on March 29, 2013

### BACKGROUND

1. Technical Field

The present invention relates to an eyeglass component, eyeglasses, and an eyeglass component manufacturing method.

2. Related Art

As shown in Japanese Patent Application Publication No. 2012-220853, for example, there are eyeglasses for stereoscopic images that include a right eye region positioned in front of the right eye of the user and a left eye region positioned in front of the left eye, having different optical axes.

However, since the right eye region and the left eye region are separate in these eyeglasses, it is difficult to handles these regions without a frame.

### SUMMARY

According to a first aspect of the present invention, provided is an eyeglass component comprising a polarization plate that has one absorption axis and a right eye region and left eye region arranged such that, when the eyeglass component is worn by a user, the right eye region is positioned in front of a right eye of the user and the left eye region is positioned in front of a left eye of the user; and a polarized light modulating layer that is layered on the polarization plate, has a first optical axis that modulates polarized light in the right eye region, includes a second optical axis that is in a different direction than the first optical axis and modulates polarized light in the left eye region, and has the right eye region and the left eye region formed integrally.

According to a second aspect of the present invention, provided is a method of manufacturing an eyeglass component, comprising forming a layered board by layering, on a polarization plate that has one absorption axis, a polarized light modulating layer in which a first region having a first optical axis that modulates polarized light and a second region having a second optical axis that is in a different direction than the first optical axis and modulates polarized light are formed integrally; and cutting out the eyeglass component from the layered board as a single body having a shape in which, when the eyeglass component is worn by a user, the first region is positioned in front of a right eye of the user and the second region is positioned in front of a left eye of the user.

The summary clause does not necessarily describe all necessary features of the embodiments of the present invention. The present invention may also be a sub-combination of the features described above.

### BRIEF DESCRIPTION OF THE DRAWINGS

FIG. 1 is a perspective view of eyeglasses 100 according to an embodiment of the present inventions.

FIG. 2 is an expanded view of the eyeglass body 110.

FIG. 3 is an exploded perspective view of the eyeglass body 110.

FIG. 4 is a cross-sectional view of the eyeglass body 110.

FIG. 5 shows an overall configuration of a manufacturing apparatus 10 for manufacturing the polarized light modulating layer 140.

FIG. 6 is a cross-sectional view of a mask 38.

FIG. 7 is a schematic view describing the steps of manufacturing the eyeglass body 110.

FIG. 8 shows another example of the eyeglass body 110.

FIG. 9 shows yet another example of the eyeglass body 110.

FIG. 10 shows yet another example of the eyeglass body 110.

FIG. 11 shows yet another example of the eyeglass body 110.

FIG. 12 shows yet another example of the eyeglass body 110.

FIG. 13 is a schematic view describing another process for manufacturing the eyeglass body 110.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

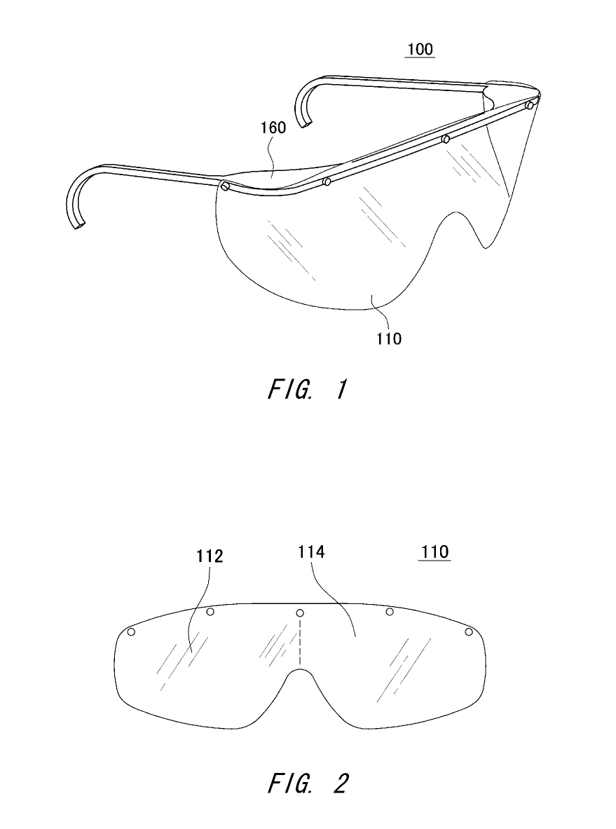

FIG. 1 is a perspective view of eyeglasses 100 according to an embodiment of the present inventions. The eyeglasses 100 include an eyeglass body 110 that modulates and passes polarized input light and a frame 160 that holds the eyeglass body 110.

FIG. 2 is an expanded view of the eyeglass body 110. In a state where the user is wearing the eyeglasses 100, the eyeglass body 110 spans a right eye region 112 that is positioned in front of the right eye of the user and a left eye region 114 that is positioned in front of the left eye of the user, and is formed integrally with the right eye region 112 and the left eye region 114. The eyeglass body 110 shown in FIG. 2 has an outline that has left-right symmetry. Instead, a protrusion, notch, or the like may be provided in a portion thereof to realize an asymmetrical shape. By forming the eyeglass body 110 to be left-right asymmetrical, the front and back sides thereof can be easily distinguished.

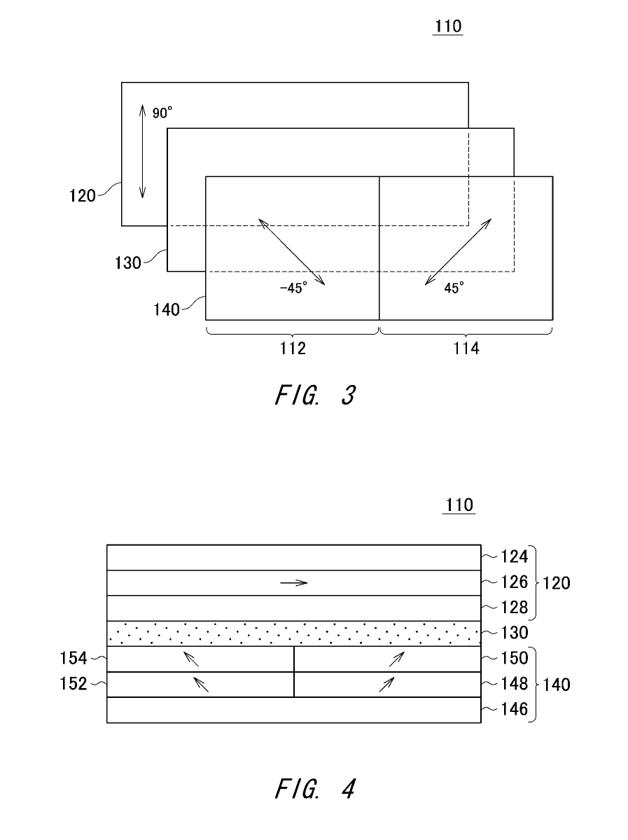

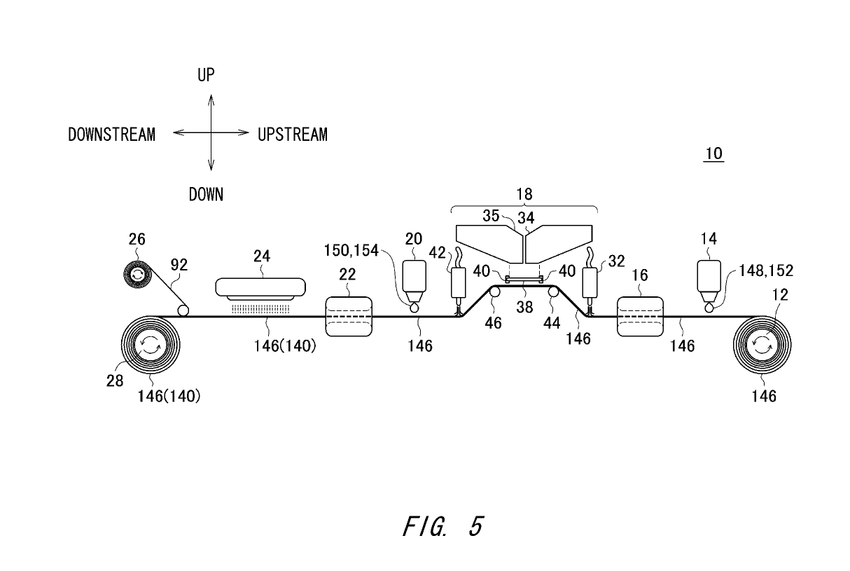

FIG. 3 is an exploded perspective view of the eyeglass body 110, and FIG. 4 is a cross-sectional view of the eyeglass body 110. In FIG. 3, a rectangular outline is shown for ease of explanation. The side that is behind the plane of the drawing in FIG. 3 and the side that is at the top in FIG. 4 are the sides that are closer to a user when wearing the eyeglasses 100. The eyeglass body 110 includes a polarization plate 120, a polarized light modulating layer 140, and an adhesive layer 130 to stack these layers.

The polarization plate 120 spans the right eye region 112 and the left eye region 114 and is formed integrally with these regions. The entire polarization plate 120 has a single absorption axis. In the example of FIG. 3, this absorption axis is at an angle of 90° relative to the horizontal direction when the eyeglasses 100 are worn, i.e. the absorption axis is vertical. The polarization plate 120 includes a light polarizing layer 126 that has a single absorption axis, and a pair of protective layers 124 and 128 that sandwich the light polarizing layer 126.

The light polarizing layer 126 is formed of polyvinyl alcohol, for example. The light polarizing layer 126 absorbs polarized light that is parallel to the absorption axis, and passes polarized light that is orthogonal to the polarization axis. The thickness of the light polarizing layer 126 may be 40 μm, for example.

The protective layers 124 and 128 can be formed by a triacetyl cellulose (TAC) film. The TAC film can be exemplified by FujiTAC T80SZ and TD80UL manufactured by Fujifilm Corporation, for example. The protective layers 124 and 128 may be formed of an isotropic material including a cyclo olefin type film. The cyclo olefin type film can be cyclo olefin polymer (COP) or a cyclo olefin copolymer (COC) that is a copolymer of a cyclo olefin polymer. The COP film can be Zeonor film ZF14 manufactured by Zeon Corporation, for example. If a cyclo olefin type film is used, it is preferable that a high-toughness film be used, in consideration of fragility.

The protective layers 124 and 128 are optically isotropic and transparent. The thickness of the protective layers 124 and 128 may be 80 μm, for example. A barcode layer or antireflection layer may be formed on the top surface of the protective layer 124 shown in FIG. 4.

The polarized light modulating layer 140 has the same shape as the polarization plate 120, spans the right eye region 112 and left eye region 114, and is formed integrally with these regions. The polarized light modulating layer 140 has a first optical axis in the right eye region 112 and a second optical axis, which is in a different direction than the first optical axis, in the left eye region 114. In the example of FIG. 3, the first optical axis is at an angle of −45° relative to the vertical direction, and the second optical axis is at an angle of +45° relative to the vertical direction. Accordingly, there is an angle of 90° between the first optical axis and the second optical axis. The polarized light modulating layer 140 may be a λ/4 retarder layer, for example. In this case, the first optical axis and the second optical axis are slow axes. The polarized light modulating layer 140 includes a base 146, orientation films 148 and 152 arranged on the base 146, and liquid crystal layers 150 and 154.

The base 146 may be formed of the same material as the protective layers 124 and 128 of the polarization plate 120, or may be formed from another material that is optically isotropic. The thickness of the base 146 may be 80 μm, for example. A barcode layer or antireflection layer may be formed on the bottom surface of the base 146 shown in FIG. 4.

The orientation film 148 is formed on the right eye region 112 of the base 146. The orientation film 152 is formed on the left eye region 114 of the base 146. The orientation film 148 and the orientation film 152 contact each other at a boundary, and are connected in a continuous manner. The orientation films 148 and 152 may have a thickness of 0.1 μm, for example.

The orientation films 148 and 152 can be a widely known photoalignment compound. The photoalignment compound is a material that, when irradiated with linearly polarized light such as infrared light, causes the polymers therein to be oriented in the polarization direction of the linearly polarized light. Furthermore, the photoalignment compound has a function that causes the polymers of the liquid crystal layers 150 and 154 formed thereon to be oriented according to the orientation of the photoalignment compound. Examples of such a photoalignment compound include photolytic type, photodimerization type, and photoisomerization type compounds. The polymers of the orientation film 148 are oriented in a direction corresponding to the first optical axis. The polymers of the orientation film 152 are oriented in a direction corresponding to the second optical axis.

The liquid crystal layer 150 is formed on the orientation film 148. The liquid crystal layer 150 can be formed by a liquid crystal polymer that can be cured through ultraviolet rays or heating, for example. The polymers of the liquid crystal layer 150 are oriented in the orientation direction of the polymers of the orientation film 148.

The orientation film 152 is formed on the liquid crystal layer 154. The liquid crystal layer 154 can be formed by a liquid crystal polymer that can be cured through ultraviolet rays or heating, for example. The polymers of the liquid crystal layer 154 are oriented in the orientation direction of the polymers of the orientation film 152.

The liquid crystal layer 150 and the liquid crystal layer 154 contact each other at a boundary, and are connected in a continuous manner. The thickness of the liquid crystal layers 150 and 154 may be from 1 μm to 2 μm, for example. The liquid crystal layers 150 and 154 modulate circularly polarized light to be linearly polarized light, and pass the resulting light.

With the configuration described above, the eyeglasses 100 are used to view stereoscopic images. Specifically, when a right eye image and a left eye image are output from a stereoscopic image display apparatus with circularly polarized light in the opposite direction from each other, the right eye region 112 passes the right eye image and blocks the left eye image, while the left eye region 114 passes the left eye image and blocks the right eye image.

FIG. 5 shows an overall configuration of a manufacturing apparatus 10 for manufacturing the polarized light modulating layer 140. The arrows labeled “up” and “down” in FIG. 5 indicate the up and down directions of the manufacturing apparatus 10. The arrows labeled “upstream” and “downstream” indicate the upstream and downstream directions for the transportation direction. The transportation direction is the same as the longitudinal direction of the polarized light modulating layer 140, and is orthogonal to the width direction of the polarized light modulating layer 140.

The manufacturing apparatus 10 includes a feeding roller 12, an orientation film applying section 14, an orientation film drying section 16, an exposure section 18, a liquid crystal layer applying section 20, a liquid crystal layer orienting section 22, a liquid crystal layer curing section 24, a separation film supplying section 26, and a winding roller 28.

The feeding roller 12 is arranged farthest downstream in the transportation path. The base 146 is wound around the circumference of the feeding roller 12. The base 146 has a width equal to the sum of the maximum width in the left-right direction of the delivered eyeglass body 110 and a certain cutting allowance, and this total width may be approximately 200 mm, for example.

The feeding roller 12 is supported in a manner to allow rotation. In this way, the feeding roller 12 can be held in a manner enabling feeding of the base 146. The feeding roller 12 may be rotatable by a drive mechanism such as a motor, or may be able to follow the rotation of the winding roller 28. As another example, the feeding roller 12 may include a mechanism for driving the base 146 within the transportation path.

The orientation film applying section 14 is arranged downstream from the feeding roller 12, and is upstream from the exposure section 18. The orientation film applying section 14 is arranged above the transportation path through which the base 146 is transported. The orientation film applying section 14 applies the orientation films 148 and 152 as liquid, which is an example of an exposure material, on the top surface of the base 146. In this state, there is no distinction between the orientation film 148 and the orientation film 152 arranged on the top surface of the base 146.

The orientation film drying section 16 is arranged downstream from the orientation film applying section 14. The orientation film drying section 16 dries the orientation film 148 and the orientation film 152 applied on the base 146 passing therethrough, using heating, light irradiation, wind, or the like.

The exposure section 18 is arranged downstream from the orientation film drying section 16. The exposure section 18 includes an up-stream air ejecting section 32, a first polarized light source 34, a second polarized light source 35, a mask 38, a mask holding section 40, a down-stream air ejecting section 42, and a pair of rollers including an up-stream tension roller 44 and down-stream tension roller 46.

The up-stream tension roller 44 and the down-stream tension roller 46 rotate along with the base 146 being transported downward. The up-stream air ejecting section 32 and the down-stream air ejecting section 42 blow air toward the top of the base 146, thereby pressing downward on the base 146 during transport.

The first polarized light source 34 outputs first polarized light, which is linearly polarized light corresponding to the first optical axis of FIG. 3. The exposure section 18 irradiates the orientation film 148 applied on the base 146 with the first polarized light output from the first polarized light source 34, through the mask 38.

The second polarized light source 35 is provided downstream from the first polarized light source 34. The second polarized light source 35 outputs second polarized light, which is linearly polarized light corresponding to the second optical axis of FIG. 3. The exposure section 18 irradiates the orientation film 152 applied on the base 146 with the second polarized light output from the second polarized light source 35, through the mask 38.

In this way, the exposure section 18 orients the polymers of the orientation films 148 and 152 to form a pattern. The polarized light output from the first polarized light source 34 and the second polarized light source 35 may be ultraviolet light with a wavelength from 280 nm to 340 nm, for example.

The liquid crystal layer applying section 20 is arranged downstream from the exposure section 18. The liquid crystal layer applying section 20 is arranged above the transportation path of the base 146. The liquid crystal layer applying section 20 applies the liquid crystal layers 150 and 154 on the orientation films 148 and 152 formed on the base 146. In this state, there is no distinction between the liquid crystal layer 150 and the liquid crystal layer 154 arranged on the top surface of the base 146.

The liquid crystal layer orienting section 22 is arranged downstream from the liquid crystal layer applying section 20. The liquid crystal layer orienting section 22 dries the orientation film 148 and the orientation film 152 passing therethrough, with the polymers of the liquid crystal layers 150 and 154 formed on the orientation films 148 and 152 being oriented in the direction of the polymers of the corresponding orientation films 148 and 152, using heating, light irradiation, wind, or the like.

The liquid crystal layer curing section 24 is arranged downstream from the liquid crystal layer orienting section 22. The liquid crystal layer curing section 24 cures the liquid crystal layers 150 and 154 through irradiation with ultraviolet light. As a result, the polymers of the liquid crystal layers 150 and 154 are secured in an orientation corresponding to the orientation of the polymers of the orientation films 148 and 152. In this way, the polarized light modulating layer 140 is manufactured.

The separation film supplying section 26 is arranged between the liquid crystal layer curing section 24 and the winding roller 28. The separation film supplying section 26 supplies and affixes a separation film 92 on the liquid crystal layers 150 and 154 of the polarized light modulating layer 140. The separation film 92 facilitates separation of the wound base 146. The separation film supplying section 26 may be omitted as desired.

The winding roller 28 is arranged downstream from the liquid crystal layer curing section 24 and is at the farthest downstream position in the transportation path. The winding roller 28 is supported in a manner to enable rotational driving. The winding roller 28 winds the polarized light modulating layer 140 that is patterned by having the orientation films 148 and 152 and liquid crystal layers 150 and 154 formed thereon.

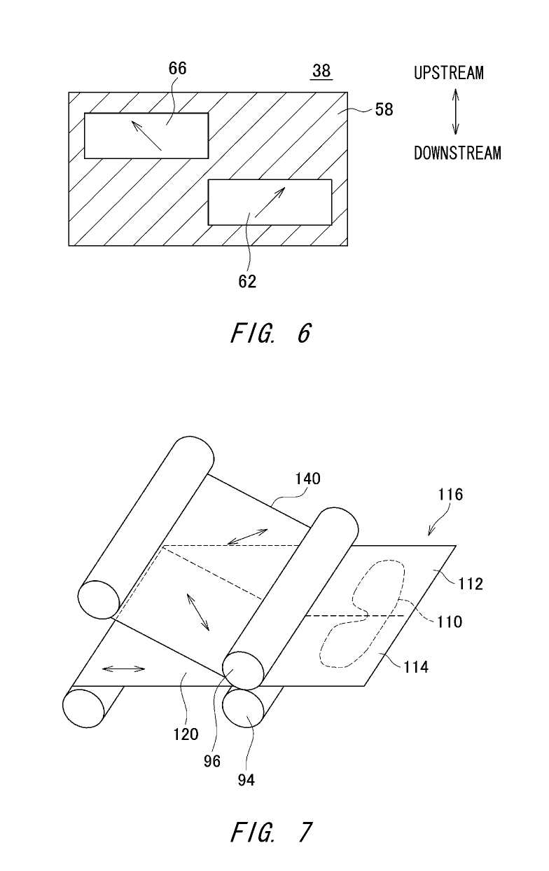

FIG. 6 is a cross-sectional view of a mask 38. The mask 38 is formed as a rectangular board. The mask 38 is formed by providing a light blocking layer 58 on a material such as quartz glass. The light blocking layer 58 is formed of a material that can block the polarized light from the first polarized light source 34 and the second polarized light source 35, such as chrome, for example. Openings are formed in the light blocking layer 58 to function as a first transmission region 62 and a second transmission region 66. The second transmission region 66 is arranged downstream from the first transmission region 62 in the transportation direction.

The first transmission region 62 is arranged between the first polarized light source 34 and the base 146. The first transmission region 62 extends from one end in the width direction of the base 146 to the center of the base 146, and passes at least the first polarized light. In this way, the first polarized light output from the first polarized light source 34 passes through the first transmission region 62, and the orientation film 148 formed on the base 146 is exposed to this first polarized light.

The second transmission region 66 is arranged between the second polarized light source 35 and the base 146. The second transmission region 66 extends from the other end in the width direction of the base 146 to the center of the base 146, and passes at least the second polarized light. In this way, the second polarized light output from the second polarized light source 35 passes through the second transmission region 66, and the orientation film 152 formed on the base 146 is exposed to this second polarized light.

The first transmission region 62 and the second transmission region 66 end at the same position in the width direction in the center of the base 146. Accordingly, the orientation film 148 formed by the first polarized light and the orientation film 152 formed by the second polarized light are connected in a continuous manner.

The first transmission region 62 may be formed by a polarization plate that is capable of passing only the first polarized light. Furthermore, the second transmission region 66 may be formed by a polarization plate that is capable of passing only the second polarized light. In this case, one of the polarized light sources may output non-polarized light to both of the regions. As another example, one of the first transmission region 62 and the second transmission region 66 may be opened across the entire width direction of the base 146.

FIG. 7 is a schematic view describing the steps of manufacturing the eyeglass body 110. A board having an absorption axis parallel to its longitudinal direction is prepared as the polarization plate 120, and the adhesive layer 130 is applied to the top surface of this polarization plate 120. The polarized light modulating layer 140 described in FIGS. 5 and 6 is prepared, the separation film is removed, and the polarized light modulating layer 140 is arranged on the polarization plate 120. The resulting structure is sandwiched between the rollers 94 and 96, thereby forming an elongated layered body 116.

The layered body 116 is cut out to have the shape shown in FIG. 2, thereby forming the eyeglass body 110. In this case, the eyeglass body 110 is cut out such that the center thereof in the right-left direction is the boundary between the right eye region 112 and the left eye region 114. This cutting out may be performed by punching the layered board in a mold.

With the present embodiment described above, the right and left portions of the eyeglass body are formed integrally, and therefore the convenience for the user is improved. Furthermore, since the right and left portions of the eyeglass body do not need to be manufactured separately, the manufacturing process can be simplified. Yet further, there is no worry of mistaking the left and right portions when attaching the eyeglass body to the frame, and therefore the workability in the manufacturing of the eyeglass can be improved.

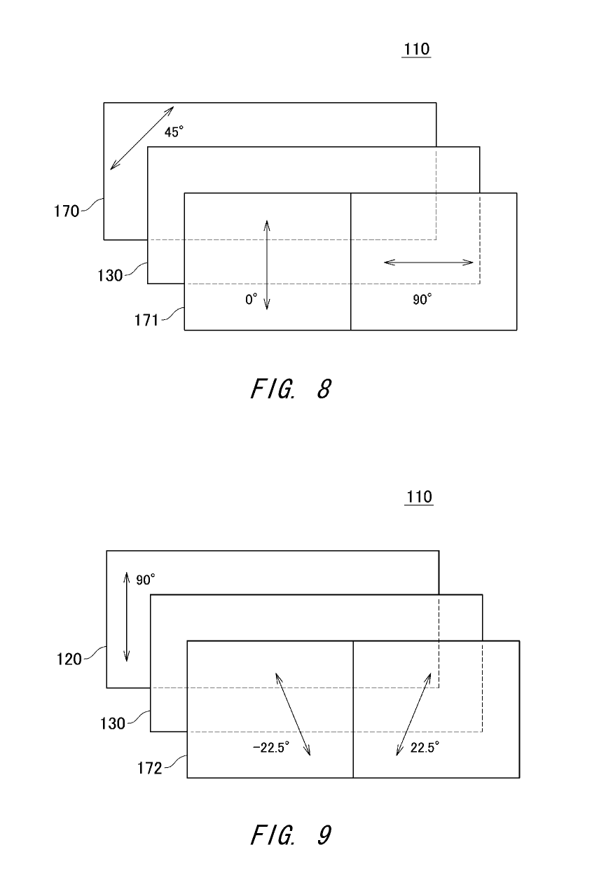

FIG. 8 shows another example of the eyeglass body 110. The eyeglass body 110 of FIG. 8 is the same as the eyeglass body 110 described in FIGS. 1 to 3, except that the optical axes of the polarization plate 170 and the polarized light modulating layer 171 are different. The following describes these optical axes. In the polarization plate 170, the optical axis forms an angle of 45° relative to the horizontal direction. The optical axis of the right eye region in the polarized light modulating layer 171 forms an angle of 0° relative to the vertical direction, and the optical axis of the left eye region forms an angle of 90° relative to the vertical direction.

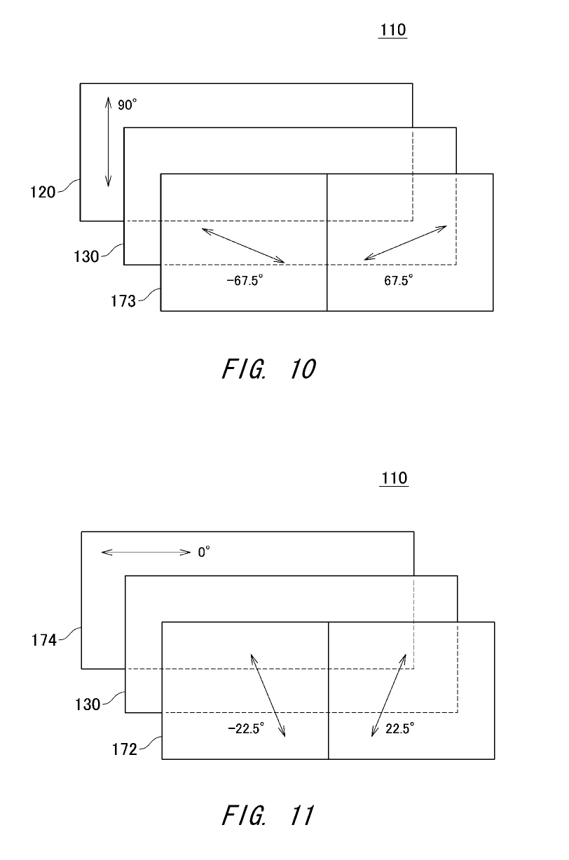

FIG. 9 shows yet another example of the eyeglass body 110. The eyeglass body 110 of FIG. 9 is the same as the eyeglass body 110 described in FIGS. 1 to 3, except for the polarized light modulating layer 172. The following describes the polarized light modulating layer 172.

The polarized light modulating layer 172 is a λ/2 retarder layer. Furthermore, the optical axis of the right eye region in the polarized light modulating layer 172 forms an angle of −22.5° relative to the vertical direction, and the optical axis of the left eye region forms an angle of 22.5° relative to the vertical direction. Accordingly, there is an angle of 45° between these two optical axes. As a result, the eyeglass body 110 of FIG. 9 can be used for a stereoscopic image in which the left eye image and the right eye image include types of linearly polarized light orthogonal to each other.

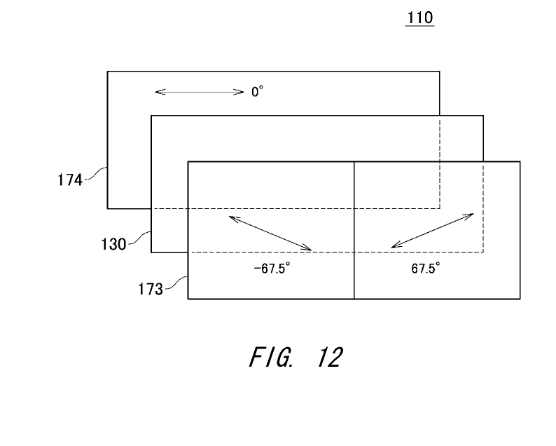

FIG. 10 shows yet another example of the eyeglass body 110. The eyeglass body 110 of FIG. 10 is the same as the eyeglass body 110 of FIG. 10, except for the optical axis of the polarized light modulating layer 173. The following describes the optical axis of the polarized light modulating layer 173. The optical axis of the right eye region in the polarized light modulating layer 173 forms an angle of −67.5° relative to the vertical direction, and the optical axis of the left eye region forms an angle of 67.5° relative to the vertical direction. Accordingly, there is an angle of 135° between these two optical axes. As a result, the eyeglass body 110 of FIG. 10 can be used for a stereoscopic image in which the left eye image and the right eye image include types of linearly polarized light orthogonal to each other.

FIG. 11 shows yet another example of the eyeglass body 110. The eyeglass body 110 of FIG. 11 is the same as the eyeglass body 110 described in FIG. 9, except for the absorption axis of the polarization plate 174. The following describes the absorption axis of the polarization plate 174. The absorption axis of the polarization plate 174 forms an angle of 0° relative to the horizontal direction.

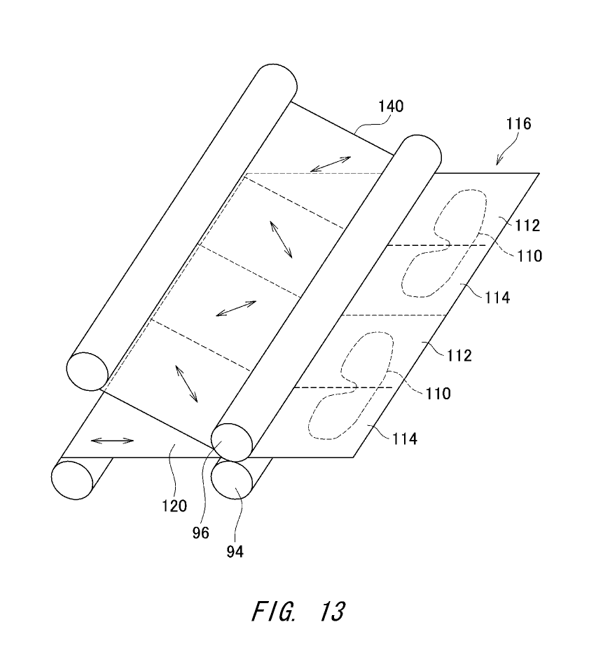

FIG. 12 shows yet another example of the eyeglass body 110. The eyeglass body 110 of FIG. 12 is the same as the eyeglass body 110 described in FIG. 10, except for the absorption axis of the polarization plate 174. The absorption axis of the polarization plate 174 forms an angle of 0° relative to the horizontal direction.

The layered structure of the eyeglass body 110 is not limited to the structure shown in FIG. 4. As another example, the structured may include the protective layer 124, the light polarizing layer 126, the protective layer 128, the adhesive layer 130, the base 146, the orientation films 148 and 152, and the liquid crystal layers 150 and 154 layered in the stated order, beginning with the side closest to the user. As yet another example, the protective layer 128 may be omitted from the structure shown in FIG. 4, when layering the polarized light modulating layer 140. As yet another example, the orientation films 148 and 152 may be deposited on the protective layer 128, and the liquid crystal layers 150 and 154 may be provided on the orientation films 148 and 152. In the embodiments described above, the right eye region 112 and the left eye region 114 of the polarized light modulating layer 140 contact each other. Instead, as long as the right eye region 112 and the left eye region 114 of the polarized light modulating layer 140 are formed integrally, another region such as a non-orienting region may be interposed between the right eye region 112 and the left eye region 114.

FIG. 13 is a schematic view describing another process for manufacturing the eyeglass body 110. The polarization plate 120 of FIG. 13 has twice the width of the polarization plate 120 of FIG. 7.

The polarized light modulating layer 140 of FIG. 13 includes two sets, each including a right eye region 112 and a left eye region 114, arranged in the width direction. This polarized light modulating layer 140 is manufactured through exposure using, instead of the mask 38 shown in FIG. 6, a mask in which there are two first transmission regions 62 spanning one second transmission region in the width direction and two second transmission regions 66 spanning one first transmission region in the width direction.

The layered body 116 is formed by applying the adhesive layer 130 on the top surface of the polarization plate 120 and affixing the polarized light modulating layer 140 thereto using the rollers 94 and 96. The eyeglass body 110 is then formed by cutting out two of the shapes shown in FIG. 2, in the width direction of the layered body 116. Furthermore, instead of the shape shown in FIG. 13, each set of the right eye region 112 and left eye region 114 may be repeatedly arranged three or more times in the polarized light modulating layer 140, and three or more eyeglass bodies 110 may be cut out in the width direction.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. An eyeglass component comprising:
a polarization plate that has one absorption axis and a right eye region and left eye region arranged such that, when the eyeglass component is worn by a user, the right eye region is positioned in front of a right eye of the user and the left eye region is positioned in front of a left eye of the user; and
a polarized light modulating layer that is layered on the polarization plate, has a first optical axis that modulates polarized light in the right eye region, includes a second optical axis that is in a different direction than the first optical axis and modulates polarized light in the left eye region, and has the right eye region and the left eye region formed integrally.

2. The eyeglass component according to claim 1, wherein
in the polarization plate, the right eye region and the left eye region are formed integrally.

3. The eyeglass component according to claim 1, wherein
the one absorption axis is arranged in a vertical direction, when the eyeglass component is worn.

4. The eyeglass component according to claim 1, wherein
the right eye region and the left eye region form a shape that is at least partially asymmetric.

5. The eyeglass component according to claim 1, wherein
the polarized light modulating layer is a λ/4 retarder layer, and an angle of 90° is formed between the first optical axis and the second optical axis.

6. The eyeglass component according to claim 1, wherein
the polarized light modulating layer is a λ/2 retarder layer, and an angle of 45° or 135° is formed between the first optical axis and the second optical axis.

7. Eyeglasses comprising:
the eyeglass component according to claim 1; and
a frame that holds the eyeglass component.

8. A method of manufacturing an eyeglass component, comprising:
forming a layered board by layering, on a polarization plate that has one absorption axis, a polarized light modulating layer in which a first region having a first optical axis that modulates polarized light and a second region having a second optical axis that is in a different direction than the first optical axis and modulates polarized light are formed integrally; and
cutting out the eyeglass component from the layered board as a single body having a shape in which, when the eyeglass component is worn by a user, the first region is positioned in front of a right eye of the user and the second region is positioned in front of a left eye of the user.

9. The method of manufacturing the eyeglass component according to claim 8, wherein
the layered board has an elongated shape and the one absorption axis is parallel to a longitudinal direction of the layered board.

10. The method of manufacturing the eyeglass component according to claim 9, wherein
the first region and the second region are repeatedly arranged in a direction orthogonal to the longitudinal direction in the polarized light modulating layer, and
the cutting out includes cutting out a plurality of eyeglass components in the direction orthogonal to the longitudinal direction.

11. The method of manufacturing the eyeglass component according to claim 8, further comprising:
forming the first region by radiating first polarized light to orient polymers therein; and
forming the second region by radiating second polarized light, which is in a different direction than the first polarized light, to orient polymers therein.
